(19) United States
(12) Patent Application Publication
(10) Pub. No.: US 2011/0050564 A1
(43) Pub. Date: Mar. 3, 2011

(54) Dynamic Picture Frame in Electronic Handset

(75) Inventors: William P. Alberth, Prairie Grove, IL (US); William S. Hede, Lake in the Hills, IL (US); Sanjay K. Jha, San Diego, CA (US)

(73) Assignee: MOTOROLA, INC., Schaumburg, IL (US)

(21) Appl. No.: 12/552,088

(22) Filed: Sep. 1, 2009

(51) Int. Cl. G09G 5/00; G06F 3/01

(52) U.S. Cl. 345/156; 715/730; 455/566

(57) ABSTRACT

A portable electronic device configured to operate in a image presentation mode that presents a sequence of images on a display component. A controller is configured to determine a context of the portable electronic device and to vary a presentation time period of images in a subset of images in the sequence relative to the presentation time period of images not in the subset, wherein the images in the subset are associated with the context of the portable electronic device.

### FIELD OF THE DISCLOSURE

The present disclosure relates generally to portable electronic devices and, more particularly, to a portable electronic device, for example, a wireless communication handset, configured to vary a multimedia output based on a context of the device.

### BACKGROUND

Digital image frames are known generally as disclosed, for example, in U.S. Pat. No. 7,107,605 entitled “Digital Image Frame and Method for Using the Same”. Also, Kim et al., in a publication entitled “Cherish: Smart Digital Photo Frames”, disclose a wirelessly connected digital photo frame client that displays photos in a “slide show” mode based on who is present or based on an event. In one proposed implementation, Kim et al. suggest rapidly changing frames to display photos of people who are present in the home, for example, a visitor ringing the doorbell. In another proposed implementation, Kim et al. propose automatically updating frames based on events specified by the user, for example, based on seasons, holidays, and birthdays.

In the mobile phone realm, Yoon et al, in a publication entitled “Context-Aware Photo Selection for Promoting Photo Consumption on a Mobile Phone”, disclose an algorithm that selects photos based on a context of a mobile phone and displays photos without interrupting the user and without requiring user interaction for photo retrieval. Yoon et al suggests that such contexts include the combination of environmental variables including time and location, social variables including call and message logs, and the current contents of the mobile phone like text messages and alarm events.

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic diagram of a portable electronic device.

FIG. 2 is a process flow diagram.

FIG. 3 illustrates a sequence of images including a subset of images associated with a location or other context of a portable electronic device.

### DETAILED DESCRIPTION

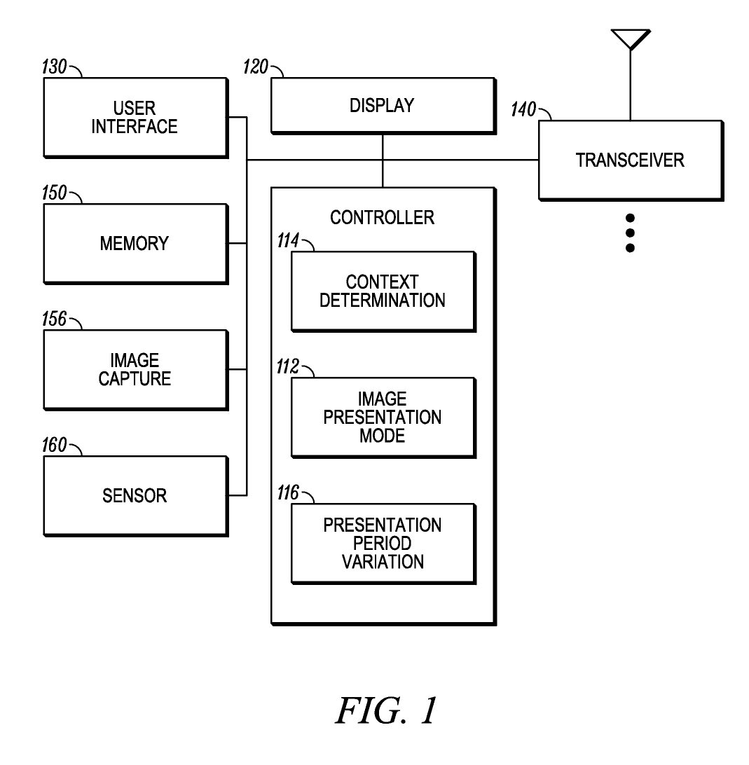

In FIG. 1, a portable electronic device 100 comprises generally a controller 110 communicably coupled to a display component 120 and to other user interface elements identified in the aggregate at 130. For example, the other user interface elements may include one or more of the following components: a keypad and/or touch screen suitable for inputting alphanumeric and other symbolic information; audio inputs and outputs; and gesture sensors among other user interface elements now know or developed later. In one embodiment, the user interface includes a video output suitable for porting video signals from the controller to an external display component.

In one implementation, the portable electronic device is embodied as a wireless communication device comprising one or more wireless transceivers 140 as illustrated in FIG. 1. For example, the transceiver may be a cellular transceiver, a WAN or LAN transceiver, a personal space transceiver like Bluetooth, a satellite transceiver, or some other wireless transceiver, or a combination of two or more of such transceivers. In other implementations, the wireless communication device is capable of only receiving or only transmitting, but not both transmitting and receiving. In another implementation, the portable electronic device is a personal electronic organizer with or without wireless communication capability.

In one embodiment, the controller is embodied as a programmable processor that executes firmware or software stored in one or more memory devices wherein the firmware or software enables some functionality of the portable electronic device. In FIG. 1, the controller 110 is coupled to a memory device 150, which may be embodied as one or more discrete devices including, but not limited to, volatile or nonvolatile memory such as a random access memory (RAM) and read-only memory (ROM) among other memory devices. Alternatively, the functionality of the portable electronic device may be implemented by equivalent hardware circuits or by a combination of software and hardware. The enablement of the basic functionality of portable electronic devices including wireless communication devices, personal electronic organizers and other portable electronic devices is known generally by those having ordinary skill in the art and is not discussed further herein. In some portable electronic devices including a programmable processor, the device includes an operating system that accommodates one or more function enabling software applications. In wireless communication device applications, the operating system could be embodied as ANDROID, WINDOWS MOBILE, SYMBIAN or some other proprietary or non-proprietary operating system. In other portable electronic devices, some other operating system may be used. More generally, however, the portable electronic device does not include an operating system to which the user may add applications. In some embodiments, the functionality is controlled by embedded software or firmware and in other embodiments the functionality is implemented by hardware equivalent circuits or a combination thereof. The particular architecture of the operating system and the processor executable programs that control the functionality of the device is not intended to limit the disclosure.

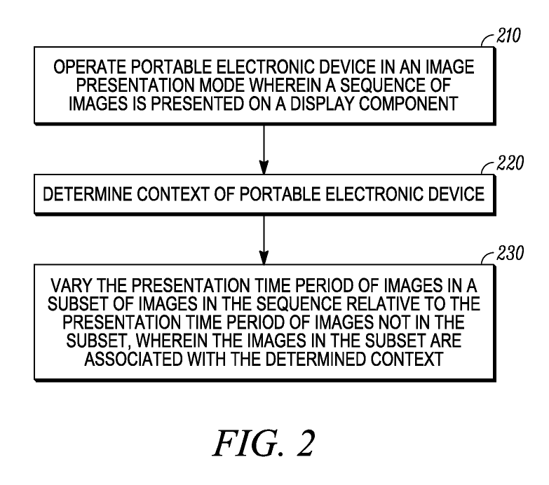

According to one aspect of the disclosure, illustrated in FIG. 2, at 210, the portable electronic device operates in an image presentation mode wherein a sequence of images is provided for presentation on a display component. In embodiments where the functionality associated with the image presentation mode is implemented by a programmable processor, software or firmware configures the processor to implement the image presentation functionality as illustrated in schematic block diagram 112 in FIG. 1. In one embodiment, the image presentation mode is implemented by an application running on an operating system. Alternatively, the image presentation mode may be implemented at a more basic level by firmware in the absence of an application-based operating system, for example in an embodiment where the portable electronic device is implemented as an electronic picture frame. In other embodiments, the image presentation mode is implemented by hardware circuits that are equivalent to at least a portion of the software or firmware configurable controller.

In some embodiments, the image presentation mode is launched by a user of the portable electronic device. In other embodiments, the image presentation mode is launched automatically. The automatic launching of the image presentation mode may be based or predicated on some context of the device. In embodiments discussed further below, a context of the device is determined based on the connection of the device to an auxiliary power source. For example, in a battery powered device, the image presentation mode may be conditioned on connection of the device to an auxiliary power source or external power supply. In some implementations, the image presentation mode is launched automatically when the device is connected to auxiliary power. Various other contexts of the portable electronic device are discussed below, any one or more of which (among others) may be used as a basis for conditioning or automatically launching the image presentation mode. The image presentation mode may also be launched if or when the device is attached to a docking station. The device may also be mechanically configured to allow the display to be visible when the device is on a tabletop. So, more generally, configuring the device mechanically may also result in launching the image presentation mode.

In the image presentation mode, each image in a sequence of images is provided for presentation on the display component for a presentation time period. One or more images may be shown simultaneously, although each image has associated therewith a presentation time period. In FIG. 1, for example, the controller is configured to read images stored in memory and output the read images for presentation or display on the display component 120, which constitutes part of the portable communication device. In other embodiments, the controller outputs the images at an output port of the portable electronic device for display on an external display component. In this latter embodiment, the images could be transmitted to the external display over a wireless or a wire-line link.

The sequence of images is pre-determined or pre-selected either by the user or some other entity. In some embodiments, the user of the portable electronic device creates a sequence of images by selecting images from a library of images stored in memory on the portable electronic device or from a library of images stored on some other remote device, for example a server. The sequence of images may also be generated or selected automatically based on a context of the portable electronic device. In some embodiments, in FIG. 1, the portable electronic device includes an imaging engine 156 with still or video image capture and storage capabilities wherein captured and stored images are selectable to form the sequence. In some embodiments, a sequence of images is created on another device, like a personal computer or a server, and copied onto the portable electronic device using a wireless or wire-line link. In some implementations, the portable electronic device includes multiple image sequences stored in memory, wherein a particular sequence may be selected by the user or selected based on some automated criterion, like context, for display when the image presentation application is run or enabled.

According to another aspect of the disclosure, illustrated in FIG. 2, at 220, a context of the portable electronic device is determined at or by the device. In one embodiment, the controller is configured to determine the context based on information obtained by a sensor 160. In embodiments where the functionality associated with context determination is implemented by a programmable processor, software or firmware configures the processor to implement the context determination functionality as illustrated in schematic block diagram 114 in FIG. 1. In one embodiment, the context determination is implemented by an application running on an operating system. Alternatively, the context determination is implemented at a more basic level by firmware in the absence of an application-based operating system. In other embodiments, the context determination functionality is implemented by hardware circuits that are equivalent to at least a portion of the software or firmware configurable controller.

In one particular implementation, a context of the portable electronic device is determined by determining whether an animate object, like a person or animal, is proximate the portable electronic device. In the context of this embodiment, detecting the presence of a person means detecting or determining that the person is within viewing distance of the display component of the portable electronic device or within viewing distance of an external display device on which the portable electronic device presents the sequence of images. In one embodiment, the controller is configured to determine the context by determining presence of a third party relative to the portable electronic device. The third party could be a user of the portable electronic device. In another embodiment, the controller is configured to determine the context by determining whether a user is logged-in to the portable electronic device. That a user is logged into the device may suggest that the user was or is proximate the device and particularly proximate the display component thereof or proximate an external display on which the portable electronic device presents the sequence of images.

In one embodiment the presence determination is performed by a sensor located on the portable communication device, for example, sensor 160 in FIG. 1. In some embodiments, the portable electronic device detects the presence of an animate object generally without specifically identifying the object. Sensors suitable for sensing presence of an animate object include but are not limited to proximity sensors, infrared sensors, and capacitive sensors among other sensing devices. In other embodiments, the portable electronic device detects the presence of the object and identifies the object at least to a limited extent. In one embodiment, an image captured with a video or image capture device is correlated with a reference image to identify an individual proximate the device. In another embodiment, the presence of a particular individual may be determined by detection of a proxy, for example, by detecting a device associated with the individual. In more particular implementation, an individual may be detected and identified by sensing a radio frequency identification (RFID) tag associated with the person, for example an ID card worn by the individual. Also, a wireless communication device associated with an individual may be detected using Bluetooth technology or by detecting an RFID tag embedded on the device or by using some other wireless detection mechanism. The particular mechanism or means by which the presence of the animate object is detected and the particular mechanism or means by which the animate object is identified are irrelevant so long as presence and in some embodiments varying degrees of identification of the person present are ascertainable.

In another implementation, the context of the portable electronic device is determined by determining the location of the portable electronic device. For example, the device may be located at a home or in an office environment or in or at some other detectable location. The determination of location also encompasses determining whether the portable electronic device is mobile or stationary. Location determination may be made using a satellite positioning system (SPS) (e.g., a GPS, GALILEO or GLONASS receiver) that determines position based on signals received from multiple space-based vehicles. Thus in FIG. 1, the sensor 160 could be a SPS receiver. In other embodiments, the location of the portable electronic device may be determined by detecting signals or beacons from other sources including but not limited to wireless communication infrastructure entities, like base stations or access points or some other wireless signal emitting device, using one or more of the receivers 140. In other embodiments, the location may be based on an assigned IP address or some other indicator. The particular mechanism or means by which the location of the portable electronic device is determined is irrelevant so long as location may be established with some degree of certainty.

In FIG. 2, at 230, while operating in the image presentation mode, the presentation time period of images in a subset of images in the sequence is varied relative to the presentation time period of images not in the subset of images. For example, the presentation time of the subset of images may be increased or decreased relative to the presentation time of images not in the subset. In embodiments where the functionality associated with varying the presentation time period is implemented by a programmable processor, software or firmware configures the processor to implement the time period variation functionality as illustrated in schematic block diagram 116 in FIG. 1. In one embodiment, the context determination is implemented by an application running on an operating system. Alternatively, the time period variation functionality is implemented at a more basic level by firmware in the absence of an application-based operating system. In other embodiments, the time period variation functionality is implemented by hardware circuits that are equivalent to at least a portion of the software or firmware configurable controller.

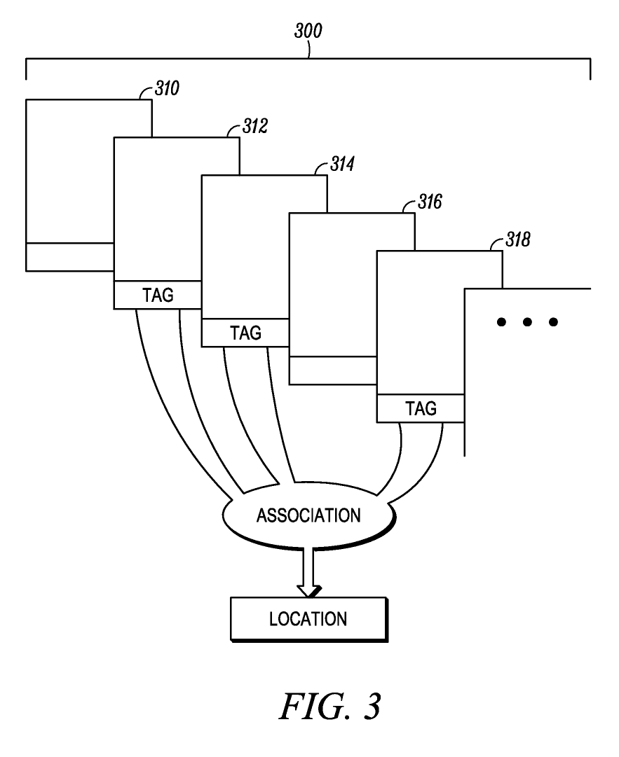

In one embodiment, a possible context of the portable electronic device is associated with a subset of images in a sequence of images. More generally, some or all images may be associated with one or more possible contexts of the portable electronic device, exemplary embodiments of which are discussed further below. Such an association may be made using metadata or tags that form a part of the corresponding image or constitute a property or characteristic thereof. FIG. 3 illustrates a sequence of images 300 including images 310, 312, 314, 316 and 318. At least some of the images have metadata associated therewith. Images 312, 314 and 318 have a meta-tag that is associated with a particular location wherein the images associated with the particular location constitute a sub-set of images as discussed further below. For example, one's office may be associated with images of home or with images of a preferred vacation destination. In another embodiment, a subset of images in a sequence is associated with a particular individual. These images may include the individual or some subject matter with which the individual has some association or connection or interest. In other embodiments, the relation between the subset of images and individual has some other basis. Generally, the association of the metadata with the context may be performed on the portable electronic device or it may occur on some other device before the images are copied onto the portable wireless communication device. A relationship or association may thus be established between a context detected by or at the portable electronic device and a subset of images in the sequence.

The assignment of metadata or tags to images including audio clips and still photos is well known generally to those having ordinary skill in the art. The metadata may be assigned or defined at the time of creation of the image or at some later time by a user of the portable wireless communication device or by some other individual or entity.

In implementations where the context of the portable electronic device is based on the presence of a third party, one or more images in a sequence of images associated with the third party define the subset of images. When the sequence of images is presented on a display component, the presentation time period of the images in the subset is varied relative to the presentation time period of images not in the subset when the third party is determined to be proximate or present relative to the portable electronic device. In this embodiment, the controller is configured to determine the context by determining presence of the third party relative to the portable electronic device and to vary, by increasing or decreasing, the presentation time period of the images in the subset when the third party is determined to be present relative to, or proximate, the portable electronic device.

In some embodiments, the selection of the image sequence including the subset of image associated with the person present is also based on the presence or proximity of the user. The detection of the presence or proximity of the user may also be used to launch the sequence of images automatically. As suggested, the launch may also be predicated on a combination of conditions, like charge level of the battery or connection to an auxiliary power supply in addition to the context of the device.

In implementations where the context is based on a user logged-in to the portable electronic device, one or more images in a sequence of images associated with the logged-in user define the subset of images. Here too, the associated images may bear any desired relation to the logged-in user. When the sequence of images is presented on a display component, the presentation time period of the images in the subset is varied relative to the presentation time period of images not in the subset when the user is logged-in to the portable electronic device. In this embodiment, the controller is configured to determine the context by determining whether the user is logged-in to the portable electronic device and to vary, by increasing or decreasing, the presentation time period of the images in the subset when the user is logged-in to the portable electronic device.

In implementations where the context is based on a location of the portable electronic device, one or more images in a sequence of images associated with the determined location define the subset of images. In one implementation, the images in the subset have a geo-tag property or attribute that is associated with one or more locations. The location may be defined generally or specifically. When the sequence of images is presented on a display component, the presentation time period of the images in the subset is varied relative to the presentation time period of images not in the subset when the portable electronic device is at the location associated with the subset of images. In this embodiment, the controller is configured to determine the context by determining the location of the portable electronic device and to vary, by increasing or decreasing, the presentation time period of the images in the subset. For example, visiting a family member's house would result in the device preferentially displaying content depicting family members or some other content selected or related to the family member's house.

In another embodiment, the controller is configured to determine the context by determining a mode of operation of the portable electronic device. The mode of operation could be social networking, web surfing, or editing, for example, the editing of power point slides or some other electronic document or file. In implementations where the context is based on a mode of operation of the portable electronic device, one or more images in a sequence of images associated with the operating mode define the subset of images. When the sequence of images is presented on a display component, the presentation time period of the images in the subset is varied relative to the presentation time period of images not in the subset when the portable electronic device operates in the mode associated with the subset. In this embodiment, the controller is configured to determine the context by determining the mode of operation of the portable electronic device and to vary, by increasing or decreasing, the presentation time period of the images in the subset when the portable electronic device operates in the mode associated with the images in the subset. If the device was recently used to create slides for a board of directors meeting then when in presentation mode pictures of the intended audience or the work group may be preferentially displayed. If the user was using the device to access alumni social networking sites, then pictures from the school or of other alumni may be preferentially displayed.

In another embodiment, the controller is configured to determine the context by determining whether the portable electronic device is coupled to an auxiliary device. One such auxiliary device is a docking station with an auxiliary power source. Another auxiliary device is a car charger or a USB cable/charger connected to a host device. In other embodiments, the auxiliary device could be a memory device or a peripheral device and need not be limited to a charging device. The connection of the portable electronic device to an auxiliary device may also be used to determine a location of the device as suggested above. A mechanical, electromechanical or electrical sensor or contacts may be used to detect whether the portable electronic device is connected to the auxiliary device.

In implementations where the context is based on whether the portable electronic device is coupled to an auxiliary device, one or more images in a sequence of images associated with the auxiliary device define the subset of images. When the sequence of images are presented on a display component, the presentation time period of the images in the subset is varied relative to the presentation time period of images not in the subset when the portable electronic device is coupled to the auxiliary device associated with the subset of images. In this embodiment, the controller is configured to determine the context by determining whether the portable electronic device is coupled to the auxiliary device and to vary, by increasing or decreasing, the presentation time period of the images in the subset. The device may detect that the user has been riding his motorcycle. When placed in presentation mode later that day, pictures associated with motorcycle trips or friends that motorcycle could be preferentially displayed.

In another embodiment, the controller is configured to determine the context by determining a weather environment in which the portable electronic device is operated or situated. The weather environment may be the temperature, humidity, or barometric pressure or combination thereof or a forecast. In implementations where the context is based on the weather environment, one or more images in a sequence of images associated with the weather environment define the subset of images. When the sequence of images are presented on a display component, the presentation time period of the images in the subset is varied relative to the presentation time period of images not in the subset when the portable electronic device is the environment associated with the subset of images. In this embodiment, the controller is configured to determine the context by determining the weather environment and to vary, by increasing or decreasing, the presentation time period of the images in the subset. In some embodiments, the weather environment may be determined based on one or more sensors, for example, a thermometer, barometer or humidistat, located on the portable electronic device. The one or more weather sensors are represented by sensor 160 in FIG. 1. Alternatively, the weather environment may be ascertained using a software application that obtains weather information based on a location of the device. When the weather is snowy and cold, the device may preferentially show pictures from the users last warm climate vacation.

In another embodiment, the controller is configured to determine the context by determining a date or the time of day. In implementations where the context is based on the date or time, one or more images in a sequence of images associated with the date or time defines the subset of images. When the sequence of images are presented on a display component, the presentation time period of the images in the subset is varied relative to the presentation time period of images not in the subset during the date or time associated with the subset of images. In this embodiment, the controller is configured to determine the context by determining the date or time and to vary, by increasing or decreasing, the presentation time period of the images in the subset. In some embodiments, the date or time may be determined based an internal clock or based on a calendar application located on the portable electronic device. As the date approaches hunting season, the device (when in presentation mode) could start preferentially show pictures from past hunting trips.

In another embodiment, the controller is configured to determine the context by determining an orientation or motion, e.g., change in position or acceleration of the portable electronic device. In implementations where the context is based on the orientation or motion, one or more images in a sequence of images associated with the motion or orientation defines the subset of images. When the sequence of images is presented on a display component, the presentation time period of the images in the subset is varied relative to the presentation time period of images not in the subset. In this embodiment, the controller is configured to determine the context by determining the orientation or motion, and to vary by increasing or decreasing, the presentation time period of the images in the subset. In some embodiments, the orientation or motion is determined based on one or more accelerometers on the portable electronic device. Through the use of accelerometers, the device may determine that the user has not been exercising or jogging, and may preferentially show pictures designed to motivate the user to continue with a workout regime.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a portable electronic device, the method comprising:
operating the device in a image presentation mode that provides a sequence of images for presentation on a display component, each image in the sequence is provided for presentation on the display component for a presentation time period when operating in the image presentation mode;
determining a context of the portable electronic device;
while operating in the image presentation mode, varying the presentation time period of images in a subset of images in the sequence of images relative to the presentation time period of images not in the subset of images,
the images in the subset of images are associated with the determined context of the portable electronic device.

2. The method of claim 1,
determining the context includes determining presence of a third party relative to the portable electronic device,
varying the presentation time period of the images in the subset of images relative to the presentation time period of images not in the subset of images when the third party is determined to be present relative to the portable electronic device,
wherein the images in the subset of images are associated with the third party.

3. The method of claim 1,
determining the context includes determining whether a user is logged-in to the portable electronic device,
varying the presentation time period of the images in the subset of images relative to the presentation time period of images not in the subset of images when the user is determined to be logged-in to the portable electronic device,
wherein the images in the subset of images are associated with the user.

4. The method of claim 1,
determining the context includes determining a location of the portable electronic device,
varying the presentation time period of the images in the subset of images based on the determined location of the portable electronic device,
wherein the images in the subset of images are associated with the location of the portable electronic device.

5. The method of claim 1,
determining the context includes determining a mode of operation of the portable electronic device,
varying the presentation time period of the images in the subset of images based on the mode of operation of the portable electronic device,
wherein the images in the subset of images are associated with the mode of operation of the portable electronic device.

6. The method of claim 1,
determining the context includes determining whether the portable electronic device is connected to a docking station with an auxiliary power source,
varying the presentation time period of the images in the subset of images based on whether the portable electronic device is coupled to the docking station.

7. The method of claim 1,
determining the context includes detecting a weather environment in which the portable electronic device is situated,
varying the presentation time period of the images in the subset of images based on the whether environment in which the portable electronic device is situated,
wherein the images in the subset of images are associated with the weather environment.

8. The method of claim 1,
determining the context includes detecting a calendar date,
varying the presentation time period of the images in the subset of images based on the calendar date,
wherein the images in the subset of images are associated with the calendar date.

9. The method of claim 1,
determining the context includes detecting a spatial orientation of the portable electronic device,
varying the presentation time period of the images in the subset of images based on the spatial orientation.

10. A portable electronic device comprising:
a controller;
a display component coupled to the controller,
the device configured to operate in a image presentation mode that presents a sequence of images on the display component wherein each image in the sequence is presented on the display component for a presentation time period when operating in the image presentation mode,
the controller configured to determine a context of the portable electronic device,
the controller configured to vary the presentation time period of images in a subset of images in the sequence of images relative to the presentation time period of images not in the subset of images while operating in the image presentation mode,
the images in the subset of images are associated with the determined context of the portable electronic device.

11. The device of claim 10,
the controller configured to determine the context by determining presence of a third party relative to the portable electronic device,
the controller configured to vary the presentation time period of the images in the subset of images when the third party is determined to be present relative to the portable electronic device,
wherein the images in the subset of images are associated with the third party.

12. The device of claim 10,
the controller configured to determine the context by determining whether a user is logged-in to the portable electronic device,
the controller configured to vary the presentation time period of the images in the subset of images when the user is determined to be logged-in to the portable electronic device,
wherein the images in the subset of images are associated with the user.

13. The device of claim 10,
the controller configured to determine the context by determining a location of the portable electronic device,
the controller configured to vary the presentation time period of the images in the subset of images based on the determined location of the portable electronic device,
wherein the images in the subset of images are associated with the location of the portable electronic device.

14. The device of claim 10,
the controller configured to determine the context by determining a mode of operation of the portable electronic device,
the controller configured to vary the presentation time period of the images in the subset of images based on the mode of operation of the portable electronic device,
wherein the images in the subset of images are associated with the mode of operation of the portable electronic device.

15. The device of claim 10,
the controller configured to determine the context by determining whether the portable electronic device is connected to a docking station with an auxiliary power source,
the controller configured to vary the presentation time period of the images in the subset of images based on whether the portable electronic device is coupled to the docking station.

16. The device of claim 10,
the controller configured to determine the context by detecting a weather environment in which the portable electronic device is situated,
the controller configured to vary the presentation time period of the images in the subset of images based on the whether environment in which the portable electronic device is situated,
wherein the images in the subset of images are associated with the weather environment.

17. The device of claim 10,
the controller configured to determine the context by detecting a time of day,
the controller configured to vary the presentation time period of the images in the subset of images based on the time of day,
wherein the images in the subset of images are associated with the time of day.

18. The device of claim 10,
the controller configured to determine the context by detecting a spatial orientation of the portable electronic device,
the controller configured to vary the presentation time period of the images in the subset of images based on the spatial orientation.
